(19) United States
(12) Patent Application Publication
(10) Pub. No.: US 2014/0173736 A1
(43) Pub. Date: Jun. 19, 2014

(54) Method and system for detecting webpage Trojan embedded

(71) Applicant: Tencent Technology (Shenzhen) Company Limited, Shenzhen (CN)

(72) Inventor: Song Liu, Shenzhen (CN)

(21) Appl. No.: 14/187,891

(22) Filed: Feb. 24, 2014

Related U.S. Application Data
(63) Continuation of application No. PCT/CN2012/077469, filed on Jun. 25, 2012.

(30) Foreign Application Priority Data
Aug. 25, 2011 (CN) 2011102455648

(51) Int. Cl. H04L 29/06

(52) U.S. Cl. CPC H04L 63/145
USPC 726/24

(57) ABSTRACT

The present disclosure is applicable to the field of computer security technology and provides a method and system for detecting webpage Trojan embedded. The method includes: obtaining webpage contents; parsing the obtain webpage contents, and extracting script objects; constructing an object execution engine to simulate the execution of the contents of the script objects; monitoring the simulation execution of the contents of the objects, and when an abnormal behaviour occurs, determining that the contents of the objects contain dangerous data. The present disclosure can effectively improve the efficiency of webpage Trojan embedded detection, and reduce the undetected rate and the error rate of webpage Trojan embedded detection.

### CLAIM OF PRIORITY

The present patent application claims the priority of Chinese patent application No. 2011102455648, entitled “A method and system for detecting webpage Trojan embedded” submitted on Aug. 25, 2011, by Applicant Tencent Technology (Shenzhen) Co., Ltd. The whole text of the present application is incorporated by reference in the present application.

### TECHNICAL FIELD

The present disclosure belongs to the field of computer security technology, more particularly relates to a method and system for detecting webpage Trojan embedded.

### BACKGROUND

Webpage Trojan embedded refers to modifying a webpage by an attacker using vulnerabilities including a third party control or a browser etc. and refers to dangerous data which can trigger vulnerabilities when deployed on the webpage. When a user uses a browser to browse a webpage with Trojan embedded, dangerous data contained in the webpage will download and install malicious software in a user system to gain control of the user system and steal user information etc. if a corresponding vulnerability exists in the system, which will pose a serious threat to the security of the user system. Therefore, it is necessary to detect webpage Trojan embedded.

Existing methods for detecting webpage Trojan embedded mainly apply construction of a huge feature database of webpages with Trojan embedded and match features of a to-be-detected webpage one by one to determine whether the webpage is a webpage with Trojan embedded. However, since webpage scripts are easily distorted and encrypted in various ways, it is inefficient to detect webpage Trojan embedded through feature matching, and the undetected rate and the error rate are relatively high.

### SUMMARY

A purpose of embodiments of the present disclosure is to provide a method and system for detecting webpage Trojan embedded, improve the efficiency of webpage Trojan embedded detection, and reduce the undetected rate and the detection error rate.

The embodiments of the present disclosure are implemented by the following way: a method for detecting webpage Trojan embedded. The method includes the following steps:

A: obtain webpage contents of a webpage;

B: parse the obtained webpage contents and extract a script object comprising object contents;

C: construct an object execution engine to simulate the object contents of the script object;

D: monitor the simulation of the object contents of the script object, and determine that the contents of the script objects comprise dangerous data when an abnormal behaviour occurs.

In another embodiment, the present disclosure provides a system for detecting webpage Trojan embedded. The system includes:

a first obtaining unit, configured to obtain webpage contents of a webpage;

an information extracting unit, configured to parse the obtained webpage contents of the webpage, and extract a script object comprising object contents;

an executing unit, configured to construct an object execution engine to simulate the object contents of the script object;

a determining unit, configured to monitor the simulation of the object contents of the script object, and determine that the object contents of the script object comprises dangerous data when an abnormal behaviour occurs.

It can be seen from the technical solution above that the embodiments of the present disclosure can detect a webpage with Trojan embedded without providing a huge feature database of webpages with Trojan embedded. Thus, a great deal of feature matching can be avoided to improve the efficiency of webpage Trojan embedded detection. In addition, multiple object execution engines are constructed to dynamically simulate the execution of the contents of the script objects, and a webpage can be determined to be a webpage with Trojan embedded when an abnormal behaviour occurs during the simulation execution process, thus effectively reducing the undetected rate and the detection error rate of webpages with Trojan embedded.

### BRIEF DESCRIPTION OF THE DRAWINGS

FIG. 1 is a flowchart illustrating implementation of a method for detecting webpage Trojan embedded in a first embodiment of the present disclosure;

FIG. 2 is a flowchart illustrating implementation of a method for detecting webpage Trojan embedded in a second embodiment of the present disclosure;

FIG. 3 is a diagram illustrating a composition structure of a system for detecting webpage Trojan embedded in a third embodiment of the present disclosure; and

FIG. 4 is a diagram illustrating a composition structure of a system for detecting webpage Trojan embedded in a fourth embodiment of the present disclosure.

### DETAILED DESCRIPTION

In order to make the purposes, technical solution and advantages of the present disclosure clearer, the present disclosure will be further described in details below in combination with the accompanying drawings and embodiments. It should be understood that the specific embodiments described herein are only used for explaining the present disclosure, instead of limiting the present disclosure.

By obtaining webpage contents, parsing the obtained webpage contents, extracting script objects, constructing an object execution engine to simulate the execution of the contents of the script objects and monitoring the simulation execution of the contents of the objects, when an abnormal behaviour occurs, the embodiments of the present disclosure determine that the contents of the objects contain dangerous data. The embodiments of the present disclosure can detect a webpage with Trojan embedded without providing a huge feature database of webpages with Trojan embedded. Thus, a great deal of feature matching can be avoided to improve the efficiency of webpage Trojan embedded detection. In addition, multiple object execution engines are constructed to dynamically simulate the execution of the contents of the script objects, and a webpage can be determined to be a webpage with Trojan embedded when an abnormal behaviour occurs during the simulation execution process, thus effectively reducing the undetected rate and the detection error rate of webpages with Trojan embedded.

In order to describe the technical solution of the present disclosure, the technical solution of the present disclosure will be described through the specific embodiments below.

### Embodiment 1

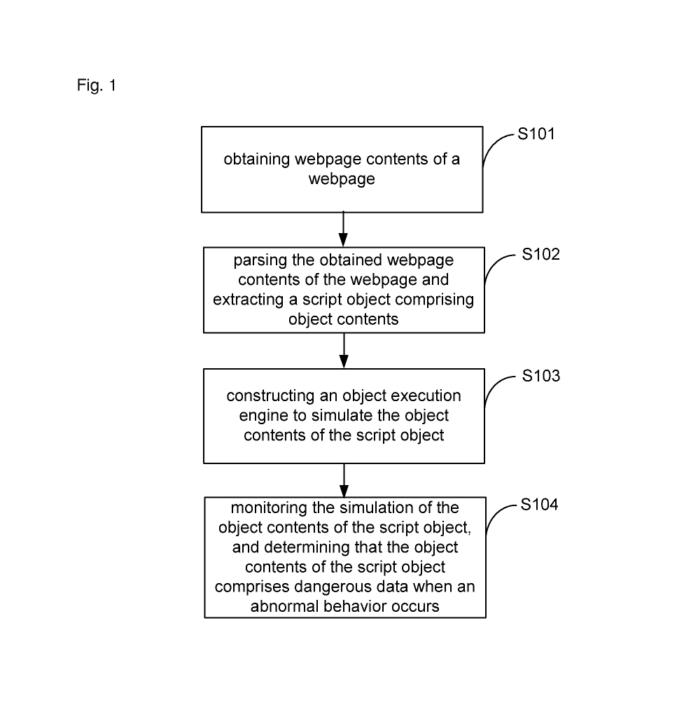

FIG. 1 is a flowchart illustrating implementation of a method for detecting webpage Trojan embedded in the first embodiment of the present disclosure. The method includes the following steps:

Step 101: obtaining webpage contents of a webpage;

in the present embodiment, the webpage contents may be obtained by an existing web crawler. At the same time, in order to improve the obtaining efficiency of the webpage contents, a filtering condition may be preset when obtaining the webpage contents to filter illegal data types and files exceeding a preset size in the webpage contents;

Step 102: parsing the webpage contents of the webpage, and extracting, from the webpage contents, a script object;

in the present embodiment, the obtained webpage contents are parsed with an existing webpage parser to extract information including tags, texts and script objects etc. The webpage contents include multiple script objects, e.g. table, title etc. Nevertheless, dangerous data usually appears in specific script objects, e.g. iframe, Uniform Resource Locator (URL) addresses referencing javascripts, Active controls (control object) and javascript codes (script object) etc.

As a preferred embodiment of the present disclosure, an object feature library of object features of script objects which may contain dangerous data is provided. Features of the obtained webpage contents are matched with the object feature library to extract script objects which may contain dangerous data.

Step 103: constructing an object execution engine to simulate the object contents of the script object;

in the present embodiment, the constructed object execution engine is a virtual machine for executing scripts. Some script objects and methods which can be used by webpages with Trojan embedded are defined in the virtual machine, e.g. javascript objects, and iframe objects etc., wherein the object contents of the subscript object include, but are not limited to javascripts, and Active controls etc. The object execution engine includes, but is not limited to a javascript interpretation engine and an Active control execution engine etc.

Preferably, constructing the object execution engine to simulate the execution of the contents of the script objects is performed by the following three ways:

a) initializing a browser object;

in order to simulate a script execution process of the browser correctly, basic browser objects need to be defined, e.g. window, document, navigator, location, . . . javascript initial scripts.

function CDocument( )
{

This.elments = “Mozilla”;

This.getElementByID = function(arg)

{
...
}
...
}
this.document = new CDocument( );

b) simulating the execution of Activex objects;

in order to detect an abnormality when a script object containing dangerous data is executed by a webpage with Trojan embedded, some script objects and methods used by the webpage with Trojan embedded need to be redefined. When the webpage with Trojan embedded executes these defined script objects and methods, the object execution engine will take over according to the following process:

1) establishing a null javascript object;

2) adding corresponding attributes and methods (e.g. list height and width etc.) to the null javascript object according to the ID of the object;

3) when invoking a vulnerability trigger function, the object is taken over by the javascript interpretation engine. The javascript interpretation engine determines, according to parameters (not limited to parameter determination) in the object, whether the object contains dangerous data. If yes, a download link of the object is obtained.

c) obtaining redirections: location, location.href, iframe.src etc.

in order to extract various redirections in the webpage, an object including location and iframe etc. needs to be self-defined and an attribute interceptor is set for the object. When a redirection statement including loction.src etc. exists in a webpage script, the interceptor will obtain a target link of the redirection statement.

Therefore, the contents of the script objects whose execution is simulated by the object execution engine also include script objects of the current webpage and script objects referenced by the webpage, e.g. :<iframe src=http://***.com width=0 height=0></iframe>, and http://***.com referenced by an iframe object.

When the object execution engine finds that a certain webpage is embedded with Trojan, the source URL of the webpage can be also captured through redirection relations among all webpages.

As an embodiment of the present disclosure, in order to enable the object execution engine to process each extracted script object correctly, the contents of the script objects need to be converted into languages which can be recognized by the object execution engine.

Step 104: monitoring the simulation of the object contents of the script object, and determining that the contents of the script object contain dangerous data when an abnormal behaviour occurs.

In the present embodiment, the dangerous data refers to data which can trigger vulnerabilities. The abnormal behaviour includes, but is not limited to whether a memory allocated during the execution of the javascripts exceeds a preset threshold or overwrites a specific address, or that the controls invoke a dangerous interface when executed.

As another embodiment of the present disclosure, the following step may be further included after Step 103: enumerating all attributes in the webpage contents by the object execution engine and detecting whether the attributes have shellcode features.

In the present embodiment, in order to further improve the detection accuracy, the object execution engine will enumerate all attributes in the web text contents after executing the script objects, and shellcode detection is performed for the attributes through an X86 emulator and a GetPC heuristic device provided by an open source library libemu.

For example, <iframe src=http://***.com width=0 height=0>, the width and height attributes are detected by the X86 emulator and the GetPC heuristic device provided by the open source library libemu. When the detected width and height attribute values are 0, it means that the attributes have shellcode features, and a webpage having the attributes may be embedded with Trojan and an alarm needs to be sent to a user timely.

By adding the shellcode detection, whether a webpage is embedded with Trojan can be detected more accurately and rapidly.

In the embodiments of the present disclosure, by obtaining webpage contents, parsing the obtained webpage contents, extracting script objects, constructing an object execution engine to simulate the execution of the contents of the script objects and monitoring the simulation execution of the contents of the objects, when an abnormal behaviour occurs, it is determined that the contents of the objects contain dangerous data. The embodiments of the present disclosure can detect a webpage with Trojan embedded without providing a huge feature database of webpages with Trojan embedded. Thus, a great deal of feature matching can be avoided to improve the efficiency of webpage Trojan embedded detection. In addition, multiple object execution engines are constructed to dynamically simulate the execution of the contents of the script objects and webpage shellcode detection to determine whether the script objects have abnormal behaviours from multiple aspects, e.g. whether a memory allocated during the execution of the javascripts exceeds a preset threshold or overwrites a specific address, or whether the controls invoke a dangerous interface when executed, and whether attribute values or parameter values of the contents of the objects are abnormal etc. are determined to effectively reduce the detection error rate of webpages with Trojan embedded.

### Embodiment 2

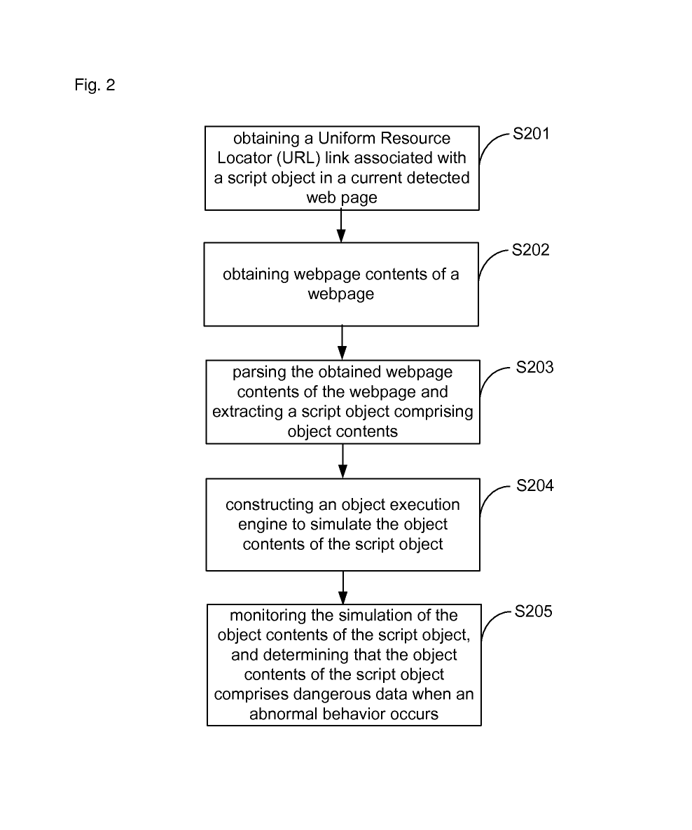

FIG. 2 shows a flowchart illustrating implementation of a method for detecting webpage Trojan embedded in the second embodiment of the present disclosure. Step 201 is added in the present embodiment based on the first embodiment, and other steps Step 202 to Step 205 are completely the same as Step 101 to Step 104 in the first embodiment.

In Step 201, a URL link associated with a script object in the current detected webpage is obtained.

In the present embodiment, in order to further protect the system security and improve the practicality and effectiveness of webpage Trojan embedded detection, when a URL link associated with a script object in the current detected webpage exists, all URL links associated with the script object need to be obtained, and steps which are the same as those in the first embodiment are performed for the associated URL links through recursion to determine whether there are script objects containing dangerous data in the associated URL links.

### Embodiment 3

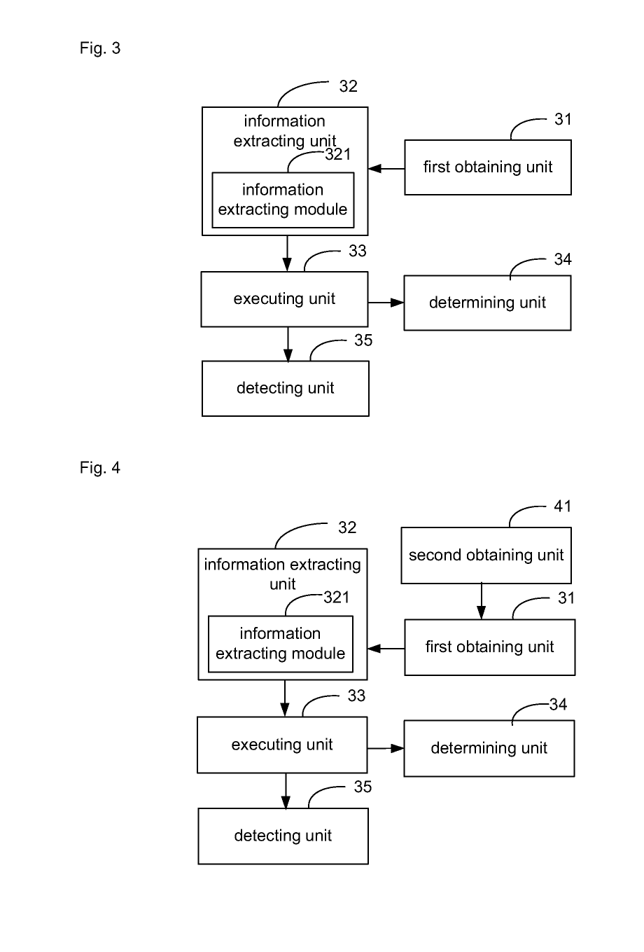

FIG. 3 shows a composition structure of a system for detecting webpage Trojan embedded in the third embodiment of the present disclosure, only parts related to present disclosure embodiment are illustrated in order to facilitate description.

The system for detecting webpage Trojan embedded may be a software unit, a hardware unit, or a unit combining software and hardware operating in all application systems.

The system for detecting webpage Trojan embedded includes a first obtaining unit 31, an information extracting unit 32, an executing unit 33 and a determining unit 34, wherein specific functions of each unit are as follows:

the first obtaining unit 31 is configured to obtain webpage contents of a webpage;

the information extracting unit 32 is configured to parse the obtained webpage contents and to extract a script object comprising object contents, wherein the information extracting unit 32 further includes an information extracting module 321. The information extracting module 321 is configured to match features of the obtained webpage contents of the webpage with features of a script object which is likely to contain dangerous data, and extract, from the features of the webpage, a script object comprising dangerous data;

the executing unit 33 is configured to construct an object execution engine to simulate the execution of the object contents of the script objects;

the determining unit 34 is configured to monitor the simulation of the object contents of the script object, and determine that the object contents of the script object comprises dangerous data when an abnormal behaviour occurs.

In the present embodiment, the contents of the objects include javascripts, and Active controls. The object execution engine includes a javascript interpretation engine and an Active control execution engine. The abnormal behaviour includes whether a memory allocated during the execution of the javascripts exceeds a preset threshold or overwrites a specific address, or that the controls invoke a dangerous interface when executed.

As another embodiment of the present disclosure, in order to further improve the detection accuracy, the system may further include a detecting unit 35 configured to numerate all attributes in the web text contents by the object execution engine and to detect whether the attributes have shellcode features.

The system for detecting webpage Trojan embedded of the present embodiment may be used in the above corresponding method for detecting webpage Trojan embedded. For more details, please refer to related description of the first embodiment of the method for detecting webpage Trojan embedded, and description will not be repeated here.

### Embodiment 4

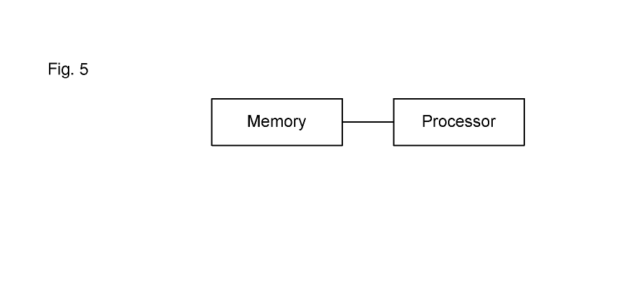

FIG. 4 shows a composition structure of a system for detecting webpage Trojan embedded in the fourth embodiment of the present disclosure, only parts related to present disclosure embodiment are illustrated in order to facilitate description.

The system for detecting webpage Trojan embedded may be a software unit, a hardware unit, or a unit combining software and hardware operating in all application systems.

In order to further protect the system security and improve the practicality and effectiveness of webpage Trojan embedded detection, a second obtaining unit 41 is added to the system for detecting webpage Trojan embedded on the basis of the third embodiment. The second obtaining unit 41 is configured to obtain URL links associated with the script objects in the current detected webpage, and to detect whether webpage contents pointed by the URL links contain dangerous data through the system of the third embodiment.

The system for detecting webpage Trojan embedded of the present embodiment may be used in the above corresponding method for detecting webpage Trojan embedded. For more details, please refer to related description of the second embodiment of the method for detecting webpage Trojan embedded, and description will not be repeated here.

In the embodiments of the present disclosure, by obtaining webpage contents of a webpage, parsing the obtained webpage contents of the webpage, extracting a script object comprising object contents, constructing an object execution engine to simulate the object contents of the script object and monitoring the simulation of the object contents of the script object, and determining that the object contents of the script object comprise dangerous data when an abnormal behaviour occurs data. The embodiments of the present disclosure can detect a webpage with Trojan embedded without providing a huge feature database of webpages with Trojan embedded. Thus, a great deal of feature matching can be avoided to improve the efficiency of webpage Trojan embedded detection. In addition, multiple object execution engines are constructed to dynamically simulate the execution of the contents of the script objects and webpage shellcode detection to determine whether the script objects have abnormal behaviours from multiple aspects, e.g. whether a memory allocated during the execution of the javascripts exceeds a preset threshold or overwrites a specific address, or whether the controls invoke a dangerous interface when executed, and whether attribute values or parameter values of the contents of the objects are abnormal etc. are determined to effectively reduce the undetected rate and the detection error rate of webpages with Trojan embedded. At the same time, in order to further protect the system security and improve the practicality and effectiveness of webpage Trojan embedded detection, when a URL link associated with a current script object exists, all URL links associated with the current script object need to be obtained, webpage Trojan embedded detection steps which are the same as those in the first embodiment are performed for the associated URL links through recursion to determine whether there are script objects containing dangerous data in the associated URL links.

Persons of ordinary skill in the art may understand that all or part of the flows in the methods according to the foregoing embodiments may be implemented by a computer program instructing relevant hardware. The program may be stored in a computer-readable storage medium. When the program is executed, the flows of the embodiments of each method may be included, wherein the storage medium may be a magnetic disk, an optical disk, a Read-Only Memory (ROM), or a Random Access Memory (RAM), and so on.

The foregoing descriptions are merely preferred embodiments of the present disclosure, but are not intended to limit the present disclosure. Any modification, equivalent replacement, or improvement etc. made within the spirit and principle of the present disclosure should all fall within the protection scope of the present disclosure.

1. A method for detecting a Trojan horse in a webpage, the method comprising:
obtaining webpage contents of a webpage;
parsing the webpage contents of the webpage, and extracting, from the webpage contents, a script object comprising object contents;
constructing an object execution engine to simulate the object contents of the script object;
monitoring the simulation of the object contents of the script object, and determining that the object contents of the script object comprise dangerous data when an abnormal behaviour occurs.

2. The method according to claim 1, wherein the step of extracting the script object comprises:
matching features of the webpage contents of the webpage with features of a script object which is likely to contain dangerous data, and extracting, from the features of the webpage, a script object comprising dangerous data.

3. The method according to claim 1, wherein the step of constructing an object execution engine to simulate the object contents of the script object comprises:
initializing a browser object;
simulating the object contents of the script object, wherein the object contents of the script object comprises an Activex object;
obtaining redirections comprised in the webpage contents of the webpage.

4. The method according to claim 1, wherein the object contents of the script object comprise javascripts, and Active controls;
the object execution engine comprises a javascript interpretation engine and an Active control execution engine;
the abnormal behaviour comprises whether a memory allocated during an execution of the javascripts exceeds a preset threshold or overwrites a specific address, or that the Active controls invoke a dangerous interface when executed.

5. The method according to claim 1, wherein the method further comprises:
obtaining a Uniform Resource Locator (URL) link associated with the script object; and
performing the method according to claim 1 on a webpage pointed by the obtained URL link, and detecting whether webpage contents of the webpage pointed by the obtained URL link comprise dangerous data.

6. The method according to claim 1, wherein after the step of constructing an object execution engine to simulate the object contents of the script object, the method further comprises:
enumerating all attributes in the webpage contents through the object execution engine and detecting whether the attributes have shellcode features.

7. A system for detecting webpage Trojan embedded, wherein the system comprises:
a first obtaining unit, configured to obtain webpage contents of a webpage;
an information extracting unit, configured to parse the webpage contents of the webpage, and extract, from the webpage contents, a script object comprising object contents;
an executing unit, configured to construct an object execution engine to simulate the object contents of the script object;
a determining unit, configured to monitor the simulation of the object contents of the script object, and determine that the object contents of the script object comprises dangerous data when an abnormal behaviour occurs.

8. The system according to claim 7, wherein the information extracting unit further comprises:
an information extracting module configured to match features of the webpage contents of the webpage with features of a script object which is likely to contain dangerous data, and extract, from the features of the webpage, a script object comprising dangerous data.

9. The system according to claim 7, wherein the executing unit is configured to construct an object execution engine to simulate the object contents of the script object through the following:
initializing a browser object;
simulating the object contents of the script object, wherein the object contents of the script object comprises an Activex object;
obtaining redirections comprised in the obtained webpage contents of the webpage.

10. The system according to claim 7, wherein the object contents of the script object comprise javascripts, and Active controls;
the object execution engine comprises a javascript interpretation engine and an Active control execution engine;
the abnormal behaviour comprises whether a memory allocated during the execution of the javascripts exceeds a preset threshold or overwrites a specific address, or that the Active controls invoke a dangerous interface when executed.

11. The system according to claim 7, wherein the system further comprises:
a second obtaining unit configured to obtain a Uniform Resource Locator (URL) link associated with the script object, and detect whether webpage contents of the webpage pointed by the obtained URL link comprise dangerous data by the first obtaining unit, the information extracting unit, the executing unit and the determining unit.

12. The system according to claim 7, wherein the system further comprises: a detecting unit configured to enumerate all attributes in the webpage contents through the object execution engine and detect whether the attributes have shellcode features.

13. The method according to claim 3, wherein the object contents of the script object comprise javascripts, and Active controls;
the object execution engine comprises a javascript interpretation engine and an Active control execution engine;
the abnormal behaviour comprises whether a memory allocated during an execution of the javascripts exceeds a preset threshold or overwrites a specific address, or that the Active controls invoke a dangerous interface when executed.

14. The method according to claim 3, wherein after the step of constructing an object execution engine to simulate the object contents of the script object, the method further comprises:
enumerating all attributes in the webpage contents through the object execution engine and detecting whether the attributes have shellcode features.

15. The system according to claim 9, wherein the object contents of the script object comprise javascripts, and Active controls;
the object execution engine comprises a javascript interpretation engine and an Active control execution engine;
the abnormal behaviour comprises whether a memory allocated during the execution of the javascripts exceeds a preset threshold or overwrites a specific address, or that the Active controls invoke a dangerous interface when executed.

16. The system according to claim 9, wherein the system further comprises:
a second obtaining unit configured to obtain a Uniform Resource Locator (URL) link associated with the script object, and detect whether webpage contents of the webpage pointed by the obtained URL link comprise dangerous data by the first obtaining unit, the information extracting unit, the executing unit and the determining unit.

17. The system according to claim 9, wherein the system further comprises: a detecting unit configured to enumerate all attributes in the webpage contents through the object execution engine and detect whether the attributes have shellcode features.

18. A non-transitory computer readable medium product, comprising instructions stored thereon, the instructions being executable by one or more processors for implementing the following:
obtaining webpage contents of a webpage;
parsing the obtained webpage contents of the webpage, and extracting a script object comprising object contents;
constructing an object execution engine to simulate the object contents of the script object;
monitoring the simulation of the object contents of the script object, and determining that the object contents of the script object comprise dangerous data when an abnormal behaviour occurs.
